(19) United States
(12) Patent Application Publication
(10) Pub. No.: US 2006/0216013 A1
(43) Pub. Date: Sep. 28, 2006

(54) Adjustment of an image recorder with dynamic measuring fields

(76) Inventors: Christian Kueblbeck, Erlangen (DE); Bernhard Froeba, Buchbach (DE)

Correspondence Address: DUANE MORRIS LLP;IP DEPARTMENT, 30 SOUTH 17TH STREET, PHILADELPHIA, PA, 19103-4196, US

(21) Appl. No.: 10/545,496

(22) PCT Filed: Feb. 11, 2004
(86) PCT No.: PCT/DE04/00246

§ 371 Date: Aug. 12, 2005

(30) Foreign Application Priority Data
Feb. 12, 2003 (DE) 103-05-851.6

(51) Int. Cl. G03B 13/34

(52) U.S. Cl. 396/121

(57) ABSTRACT

A method for altering the recording setting of an image recorder for the recording of an object is disclosed. A setting influencing at least the recording of the object, such as aperture, illumination time or focussing (30,40,50), is controlled using at least one object section (1a; 1b) in the object image (60). The object section is selected by means of a previously determined/fixed object type (9). The determined type is localized in the object image (1) by means of an image analysis (10) to give localisation information (PD). The object section (20) is determined from the localisation information to influence the setting of the image recorder from the at least one fixed object section (1a,1b).

The invention relates to a method or an apparatus according to claims 1 or 12. Here it is referred to image recorders for the recording of an object, that is, the image data of the object. Insofar the object is to be understood such that the object image represents the recording. In the description hereinafter it is also often referred to the object.

In photo cameras there are systems for automatically adjusting the focus (called auto-focus). Hereby, an image area selected in advance by the camera by is typically taken from the centre of the image. Various methods are applied to this image area. These methods may include the measurement of distances, if an auto-focus is desired. These methods may also include an automatic adjustment of aperture and/or illumination time (a so-called program automatic system). To this end, the brightness of the image area of interest is used and an evaluation and adjustment is performed. Alternatively to the selected centre measurement a spot measurement may be performed, if a small section is selected in the centre of the object image, from which the illumination information used for the adjustment of the camera is derived. Moreover, a plurality of positions may be used, which may be combined with the aforementioned spot measurement, either weighted or non-weighted.

The invention relates to an improved system that automatically adapts to the image information. It is not always ensured that the area of interest is located in the centre of the image. It is not always ensured that the spot measurement yields the correct illumination. A measurement with emphasis of the centre is in most cases not a satisfactory solution, since light and colour influences affect the adjustment of the image recorder, which may not be desired by the recording person (the user of the image recording device).

It is the object of the invention to provide a recording device with automatic adjustment that allows enhanced or improved application-specific adaptability.

The object is solved by a solution according to claims 1, 12 or 14. The invention extends the possibilities offered by an image recorder. Instead of static points or fields a measurement of dynamic fields is performed. The dynamic is determined by the image rather than by the camera (claim 14). The focus length, the aperture or the illumination or focus settings are dynamically controlled in such a manner that the image itself determines which position or which area of the image (object section) is used for the control of the camera. The adjustment of the camera is at least such that the recording of the object is affected. The focusing and aperture and illumination time are preferred aspects as well as the combination of focusing and at least one of the settings of aperture/illumination (claims 2, 3 and 4).

The image sections (fields or points) to be evaluated are selected such that prior to releasing the image recorder, or prior to starting the recording of a video recording device, a specific type of object type is pre-selected by the user (claim 1).

Such types of object types may represent faces (claim 10, claim 15). These should be represented in a focused manner and/or well-illuminated with respect to the object image.

Prior to the determination of the parameters for the adjustment of the recorded image there are performed the presetting of an object type (by the user) and the automatic evaluation of the system for obtaining those positions in the object image that correspond to the object type.

In addition to the position also the size, at least approximately, may be determined.

Thus, by means of the detection algorithm the selected object types are searched in the image, thereby affecting or altering the selection of the measurement points or measurement fields, which are used for the determination of parameters (claims 5, 6).

Several (identical) object types may also be present in the object image (claim 7); position data are then obtained for each section, which determines the position of the respective section within the (total) object image, or which is thus determined with respect to their positions (claim 11).

In case of a plurality of image sections of the object type (claim 7) the depth of focus may be optimised (claim 9).

A supporting co-control may be performed on the basis of selected non-movable (smaller) fields (claim 13). They are permanently selected in the object image (on the image sensor in the device).

Exemplary embodiments supplement and explain the invention.

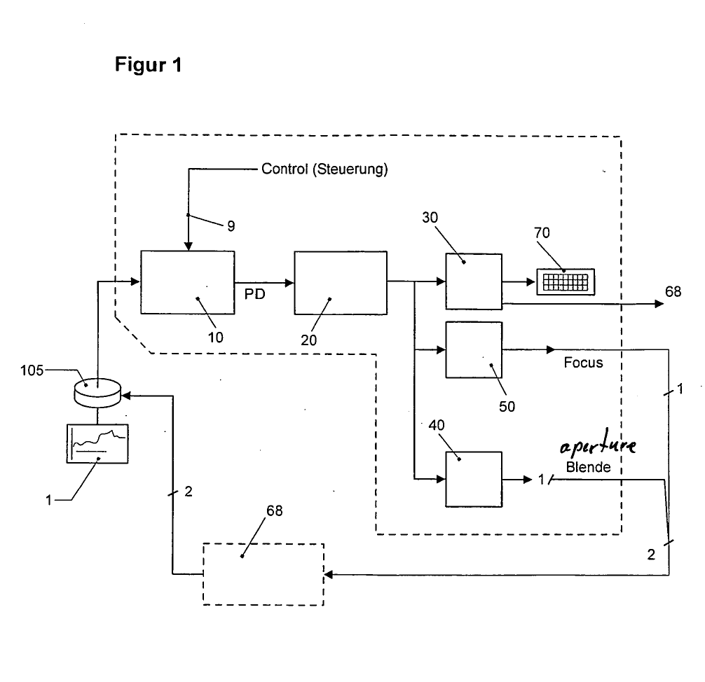

FIG. 1 is a block circuit diagram of a first embodiment.

FIG. 1a is a recording apparatus 100.

FIG. 2 is an illustrative functional diagram according to the block circuit diagram of FIG. 1, including a respective illustration of the operation during the recording of an image.

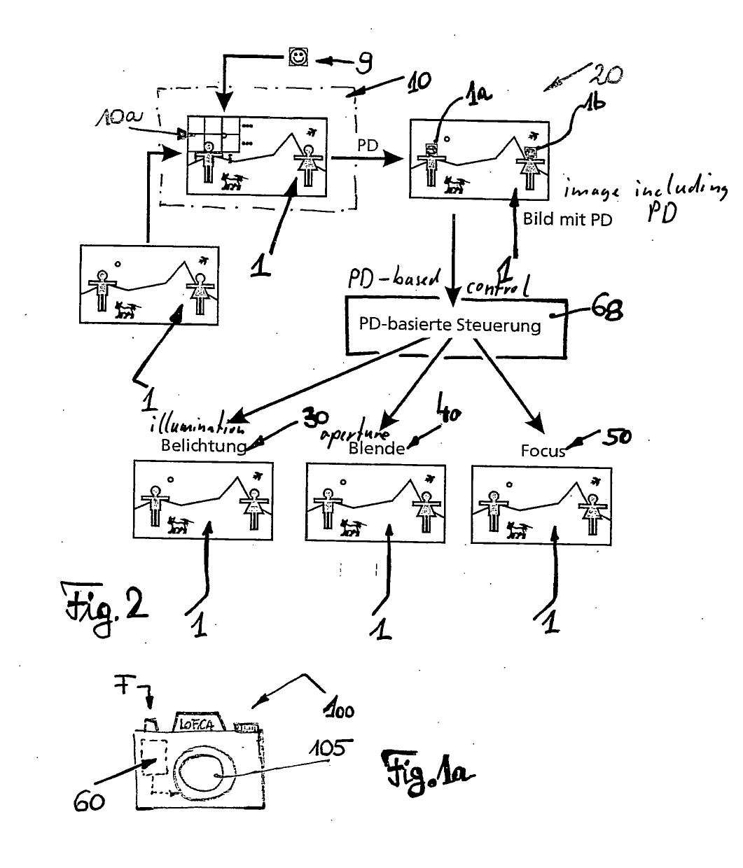

FIG. 3 is a graphic representation of an focus setting according to the block circuit diagram of FIG. 1

FIG. 4 is a graphic representation of the illumination setting according to the embodiment of FIG. 1.

On the basis of the recording apparatus 100 of FIG. 1a the mode of operation may be described, according to which the method of influencing or altering the setting of recording of the image recorder 100 operates in order to record an object that may, for instance, be a person or a technical object, such as a screw or a wheel to name an industrial application. The example of a camera 100 is not specifically restricting; rather, other image recorders may also be used, such as a video camera—not shown—having a sequence of images, or an industrial recording device for monitoring the manufacturing process or processing of one of the aforementioned technical objects. The recording of a single image is to be described, while the recording of this single image may also be applied to a sequence of images, wherein a focus setting, an illumination setting, a setting of the aperture or any combination thereof is to be applied to each image of the sequence.

The photo camera 100 of FIG. 1a operates with a recoding lens 105. Within a portion 60 of this camera is provided the control technique for the adjustment of the recording.

To this end, motor drives may be provided to adjust the aperture position or the focus position of the lens 105. The (electronic) adjustment of the illumination time may be controlled by an electronic unit 68. The electronic unit may control a motion of the shutter (in the form of an iris aperture or a blade aperture), thereby also controlling the open time (illumination time) (mechanical shutter).

A recording of an object occurs, wherein the object is for example the image according to FIG. 2. Other objects are shown in FIG. 3 and FIG. 4 as individuals in front of a difficult (mostly bright) background. The recording of the object results in an object image or “an image of the object”, which after or during the recording operation is referred to as an “object”, which in the present case represent the pictorial representation that corresponds to the original object in a pixel-oriented manner. The recording of the object is performed with at least one changing setting, such as aperture, illumination time or focus, wherein an object section in the object image controls the at least one setting.

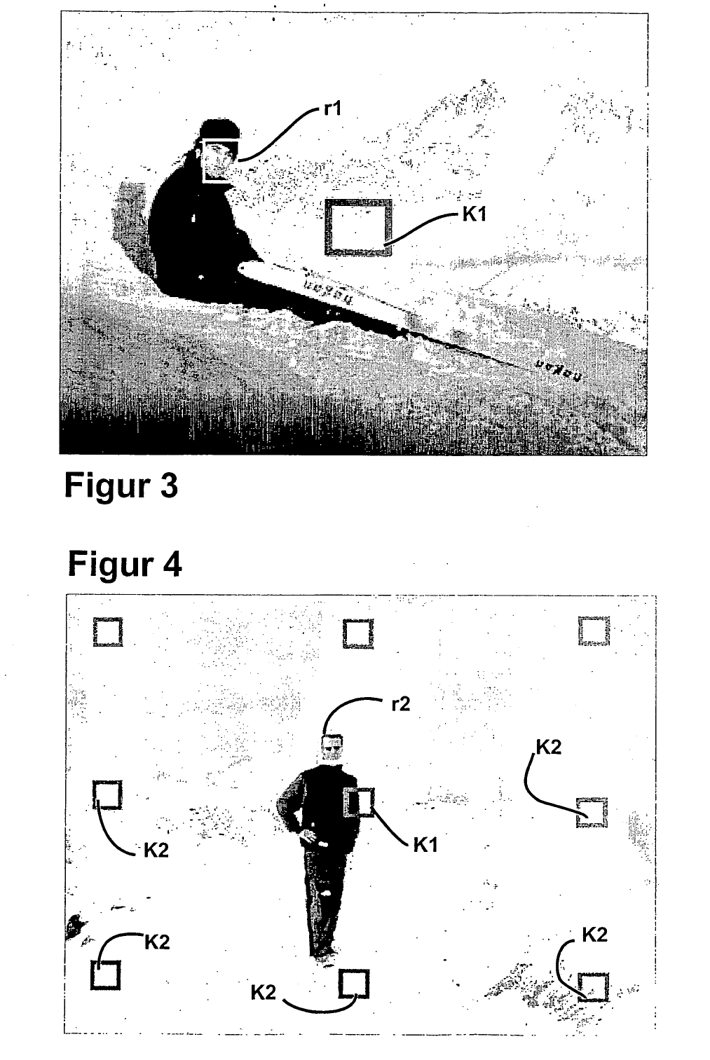

For controlling, i.e., influencing the way of recording, first an object section is identified in the recording object image 1. This identification or localization is pre-defined with respect to its type, which is accomplished by selecting an object type via a user interface 9. For example, the object type may be a face that is defined by features or edge lines, such as a pattern or model according to DE-C 100 43 460 (Fraunhofer association); cf. the evaluation of edge information, the generation of a model according to FIG. 8 of that document and the manner of localising of a face according to FIGS. 6, 6a and FIG. 7 of that document, with reference to the passages of the description associated therewith, in particular paragraph 084 to 086 in columns 13, 14. Further is disclosed therein the position information and size information, cf. paragraph 079, column 12. The search of the total image 1 with respect to a specific object type is symbolized by the 2×3 array 10a in FIG. 2. This array 10a is symbolically indicated in the image, but is functionally performed by a function unit 10, which is given the object type 9 in advance. The start value of this function unit is position information PD (position data), which identifies in the image 1 the object searched for, such as is for instance shown in FIG. 2 at 1a and 1b. Hereby, also a plurality of area sections may be identified, in which there is recognized an object type pre-selected by the user via the interface 9.

In a means 20 the position data PD is used to set image sections as object sections and to characterise the data in data processing fashion. Frames r1, r2, in which faces have been identified, are symbolically depicted in the respective more illustrative FIGS. 3 and 4, wherein the frames are recognized by the search 10 by means of position and size and are set within the image in a defined manner. The object section located and defined in this way is set with respect to its type, has been located within the object image by the image evaluation (search 10), and is used for controlling of the lens setting or the time setting of the image recorder 100.

From the object section that image information, at least a significant amount thereof, is used that resides within the section. From the image information a brightness value (in the form of a mean value) may be obtained, contrast information may be evaluated, or a focus setting may be aligned to this area 1a or 1b that is indicated by frames comparable to the frames r1, r2 of FIGS. 3, 4. With this image information (in the general meaning) from the at least one set object section the setting is altered by control means 30, 40 or 50 of FIG. 1, with respect to the camera lens 105 or the focus length setting or the focus setting.

The corresponding control means in the form of PD-based controller 68 are implemented in the individual components 30, 40, 50, which may act individually or in any combination to alter the camera setting.

The illustrative block circuit diagram of FIG. 2 makes clear the illumination adjustment 30, the aperture adjustment 40 and the focus adjustment 50 each with respect to object image 1 currently being present in the viewer and which is being altered in its recording parameters correspondingly to the PD information.

It can be operated with one object section only. However, several object sections may be involved, which may commonly be used. For example, the object section 1a and the object section 1b that are placed before the image recorder so as to not have the same distance therefrom, may adjust, by selecting of a corresponding setting of the aperture, a depth of focus at which both object sections are still sufficiently focused within the region of the depth of focus. This is an example for an aperture setting 40 that would entail a corresponding automated illumination adjustment 30, 68 as is compatible with the environmental brightness.

Is a brightness adjustment to be performed at the same time, this can also be accomplished within the object section recognized, which in particular may readily be appreciated by the person skilled in this field in the case of sophisticated environmental conditions according to FIG. 4. The face would be entirely underexposed, if the camera were to operate with an illumination setting that is based on a mean value of the total brightness of the entire image. Also, an averaged brightness obtained, for instance, from the central exposure field K1 would not help in this case, since again an exposure or illumination time would be too long.

The further exposure fields having reduced dimensions, in the following referred to as K2 and being arranged around the image perimeter, are evidently also inappropriate, after the sky, the snow and further bright items would have been measured for the illumination adjustment, whereas the illumination field r2 exactly extracts that area of the image that is substantially relevant for the illumination.

In particular, in the case of portable cameras and video cameras an altering of the described settings by automatically adapting to the object is advantageous. Frequently, the object is shifted away from the image centre, which in particular in FIG. 3 including the central illumination measurement field K1 would be located next to the actually interesting illumination area r1.

The area-like measurement fields r2, r1 of FIGS. 3, 4, which are detected by the search 10 and are identified in the image by the setting means 20, form an adaptive adjustment possibility, in which during the recording of the object (or prior to the recording) one of the described technical parameters is controlled on the basis of the object image. Hereby, the object section, which causes the control operation, is dependent on the object image and is not determined by the camera or the image recorder, as is symbolically indicated by the exemplarily given measurement fields K1 and K2.

If the person depicted in FIG. 4 slightly moves to the left (any movements to the right are critical due to the geographical environment), also the measurement field r2 moves along with the person. Thus, the object section becomes dependent on the object image, in particular with respect to its position (for a lateral movement) or with respect to its size (for a movement towards to the camera or away from the camera). The face determines the substantial fraction of the field that is used for controlling the camera. At least one of the technical parameters described is controlled by this object section, or is at least influenced, which should mean that an exclusive influencing may not be necessary, but instead a joint influencing may occur. Other parameters, such as, for instance, the measurement field K1 and K2 normally provided (or more of these fields) may also supportingly contribute to be able to accommodate and appropriately expose difficult image situations and to obtain satisfactory image results.

For finding the object information, i.e., the position data, the entire image 1 may be searched. Hereby, also the information is obtained as to how many of the object types that are looked for, are present in the total image. If several object types are present, the user may select which one of these several object section he wishes to use, or he allows the employment of several section for controlling the camera setting.

In addition to an adjustment also a display 70 may be provided, which may inform about the number of object sections obtained as determining measurement areas r2, r1, if necessary may determine those object sections used for the controlling, or provides other control information that may be relevant to the user during the recording.

In FIG. 3 there is shown the photo of a person in front of a difficult background. If the user wishes to always adjust the depth of focus on the basis of the faces being present in the image, a focusing 40 is performed using the area r1 instead of using normally provided focusing on the measurement field K1.

The focusing is performed substantially more precisely, as the person to be focused is not located in the centre of the image bur is slightly laterally offset with respect to a centre-based focusing.

If several persons are present in the image of FIG. 3, by adjusting a depth of focus a focus setting may be obtained which results in a setting of the aperture. Moreover, a combination of the fixed area K1 and the dynamic measurement field r1 may be used, wherein the usual (fixed with respect to the camera) area for the focus adjustment and also the moved area r1 determined by the object are used for the adjustment.

Hereby, it is again to be appreciated that the position of the object type in the image is not depending on the camera, but instead is determined by the image of the object, i.e., the object image. When the person is moving across the image, the measurement field r1 (or r2 or 1a or 1b) is also moving along with the person, even though the camera itself with its alignment and the remaining background remain unaltered.

In FIG. 4 an example of an illumination setting is shown. Usually, the brightness is determined by evaluating a plurality of areas, which are exemplarily provided as K2 and eight measurement fields K2 associated therewith. Measurement field K1 may be added so that a mean value obtained from nine exposure fields may be used.

Alternatively or additionally also the brightness of a face area may be used, which has previously been indicated as r2. This face area is determined by the position data PD, has been obtained by the search 10 may be used in the illumination adjustment.

In this manner, the illumination of the face may be enhanced. The bright/white background with its pronounced effect, which may be considered as difficult, is of reduced influence in the recorded image.

We claim:

1. A method of altering a recording setting of an image recorder for recording an object;
wherein a setting, which has at least a joint influence on the recording of the object, such as aperture, illumination time or focusing (30, 40, 50), is controlled (60) by at least one object section (1a; 1b) in the object image;
said object section is selected according to a type (9) and is located (PD) in the object image (1) using an image evaluation (10) for outputting position information (PD);
said object section is determined (29) from said position information to influence said setting using image information from the at least one determined object section (1a, 1b).

2. The method of claim 1, wherein said setting is a focus setting (50).

3. The method of claim 1, wherein said setting is an aperture setting (40).

4. The method of claim 1 or 3, wherein said setting is an illumination setting (30).

5. The method of claim 1, wherein said image recorder is a video camera or photo camera, in particular for a private user or an industrial application.

6. The method of the preceding claim, wherein said camera (100) or video camera is portable.

7. The method of claim 1, wherein a plurality of object sections are determined in said object image, a plurality of position data is obtained as a respective group and said setting is controlled using the image information of the plurality of object sections.

8. The method of claim 1, wherein an object section (1a, 1b) is an area-like measurement field.

9. The method of claim 1 or 7, wherein during the detection of a plurality of object sections in an image additionally a depth of focus is adapted using said aperture setting such that each object section is imaged in a substantially focused manner.

10. The method of claim 1, wherein the object type is determined by a user, for instance as a face or a technical object, such as a car, a screw or a wheel.

11. The method of claim 1, wherein substantially all of the image of the object (object image) is subjected to calculation (20), for which the type of object (object type) is determined in advance and which obtains said object sections from the image information by yielding position information (PD) and which forwards (60) respective data to a further circuit.

12. An image recorder for recording of an object by pictorial representation of image information of the object, comprising means (60, 68), which are operable according to a method of any one of the preceding claims.

13. The method of claim 1, wherein in addition to the controlling of the setting also a joint controlling of the same setting is performed using at least one image section (K1, K2) that is fixed in position within said object image.

14. A method of altering a recording setting of an image recorder (10) for recording an object;
wherein a setting,—at least jointly influencing the recording of the object—, such as aperture, illumination time or focusing (30, 40, 50) is controlled (60) by at least one object section (1a; 1b; r1, r2) in the object image (1);
wherein said object section is dependent on said object image, in particular on its position in the image of the object or its size in the image of the object.

15. The method of the preceding claim, wherein a face as an object section (r1, r2) in the object image determines a position and a size of the object section, by means of which said setting—at least jointly influencing the recording of the object—is controlled or is controllable (60).

16. An apparatus for recording of an image comprising control means (60, 68), which is operable according to any one of the two preceding claims.
